(19) United States
(12) Patent Application Publication
(10) Pub. No.: US 2009/0258589 A1
(43) Pub. Date: Oct. 15, 2009

(54) KNIFE ASSEMBLY

(75) Inventor: Alan Dwayne PUGH, Windsor, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: SF Investments, Inc., Wilmington, DE (US)

(21) Appl. No.: 12/103,478

(22) Filed: Apr. 15, 2008

(51) Int. Cl. A22C 11/00

(52) U.S. Cl. 452/50

(57) ABSTRACT

A knife assembly for removing a meat casing including a base member adapted to be mounted to a support structure, the base member includes a cutting assembly mounting portion having a first opening located on a surface of the base member and a slot, the slot extending from the first opening toward another surface of the base member. The knife assembly also includes a cutting assembly having a mounting arm configured to engage the slot to couple the cutting assembly to the base member and a cutting blade portion adapted to hold a blade, wherein at least a portion of a sharp edge of the blade is exposed.

### BACKGROUND

1. Field of the Art

The present embodiments relate generally to a knife assembly, and more particularly to a knife assembly that can be mounted and used to remove the casing of a sausage.

2. Description of Related Art

Sausages for human consumption come in a variety of compositions and sizes but are generally elongated and cylindrical in shape. Sausages are typically made by stuffing ingredients—predominately meat products—into a casing, which may be made of natural ingredients or artificial ingredients.

The sausage production cycle generally includes the steps of grinding, blending, stuffing, and packaging. Sometimes a product that has partially or fully completed the production cycle is not sellable but is still wholesome, and can be used for food. For example, the casing of some sausages may split during the cooking or smoking cycle, may be misshapen, or may have an inadequate amount of contents. Manufacturers are allowed to reuse the edible but unsalable products by removing the casing and recycling the contents back to the grinding step for inclusion in another run of the same product. This “rework” is common practice in the industry.

To rework a sausage, operators typically take out an unsalable sausage from the production line and fully remove its casing in order to recycle its contents. To do this, operators typically use hand-held knives to manually remove the casings. A significant and common problem with operators using hand-held knives to remove casings is that it often results in operator injury. Because the sausages are difficult to grasp firmly in only one hand while trying to manipulate an exposed blade in the other hand, operators are frequently injured. In many cases, such injuries are non-superficial and can lead to recordable injuries, resulting in missed time. Another significant problem is that removing the casings using conventional hand-held knives can be time consuming and slow down the overall process. Casing removal mechanisms are not used because they too cumbersome, expensive, and inefficient for this limited purpose.

The description herein of certain advantages and disadvantages of known devices and methods, is not intended to limit the scope of the embodiments. Indeed, the embodiments may include some or all of devices and methods described above without suffering from the same disadvantages.

### SUMMARY

In view of the foregoing, the present embodiments provide a simple, safe, and effective cutting device for removing meat casings. One embodiment provides a knife assembly for removing a meat casing, the assembly comprising a base member adapted to be mounted to a support structure, the base member comprising a cutting assembly mounting portion having a first opening located on a surface of the base member and a slot, the slot extending from the first opening toward another surface of the base member; a cutting assembly comprising a mounting arm configured to engage the slot to couple the cutting assembly to the base member; a cutting blade portion adapted to hold a blade, wherein at least a portion of a sharp edge of the blade is exposed.

Another embodiment provides a knife assembly for removing a meat casing, the assembly comprising a base member comprising a mounting portion adapted to mount to a support structure and a cutting assembly mounting portion; and a cutting assembly adapted to mount to the cutting assembly mounting portion, the cutting assembly comprising a blade, wherein at least a portion of a sharp edge of the blade is exposed.

Another embodiment provides a knife assembly for removing a meat casing, the assembly comprising a base member adapted to be mounted to a support structure, the base member comprising a cutting assembly mounting portion; a cutting assembly comprising a mounting arm configured to engage the cutting assembly mounting portion; a cutting blade portion adapted to hold a blade; and wherein the mounting arm and cutting blade portion are joined at an angle to allow the cutting blade portion to reside atop the base member when the cutting assembly is coupled to the base member.

### BRIEF DESCRIPTION OF THE DRAWINGS

Purposes and advantages of the exemplary embodiments will be apparent to those of ordinary skill in the art from the following detailed description together with the appended drawings, in which like reference numerals are used to indicate like elements:

FIG. 1A is a perspective view of a knife assembly, in accordance with an exemplary embodiment;

FIG. 1B is a perspective view of a knife assembly, in accordance with an exemplary embodiment;

FIG. 2 is a side elevation view of a knife assembly, in accordance with an exemplary embodiment;

FIG. 3 is a perspective view of a removable cutting member for a knife assembly, in accordance with an exemplary embodiment;

FIG. 4 is a perspective view of a removable cutting member for a knife assembly, in accordance with an exemplary embodiment;

FIG. 5 is a front elevation view of a knife assembly, in accordance with an exemplary embodiment; and

FIG. 6 is a back elevation view of a knife assembly, in accordance with an exemplary embodiment.

### DETAILED DESCRIPTION OF PREFERRED EMBODIMENTS

Various embodiments described herein provide a knife assembly that can be used to remove meat casings. For purposes of clarity and illustration only, the devices and methods of the exemplary embodiments are generally described herein in relation to removal of a sausage casing. However, the devices and methods of the present embodiments can be used with alternative processes.

The exemplary embodiments will now be described more fully with reference to the accompanying drawings in which some, but not all, exemplary embodiments are illustrated. In the drawings, like reference numerals are used to refer to like elements.

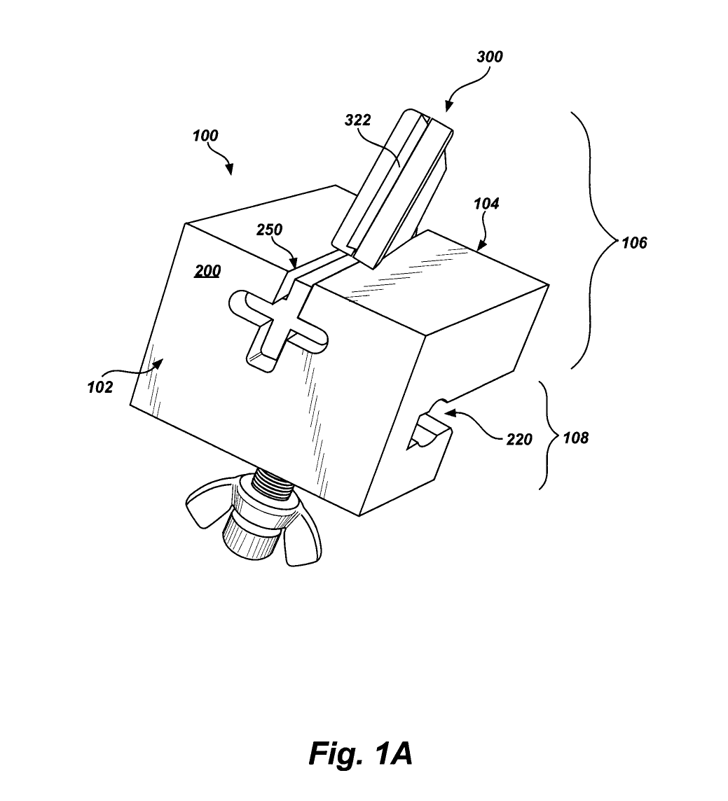

FIGS. 1A and 1B illustrate an exemplary embodiment of a knife assembly 100 generally having a front portion 102, a back portion 104, an upper portion 106, and a lower portion 108. The knife assembly 100 may further have a base member 200 and a cutting assembly 300. Generally, the knife assembly 100 may be configured so that the base member 200 may be rigidly, but removably, attached to a support structure and the cutting assembly 300 may be mounted on the base member 200 so that a cutting blade 322 faces upward. In this configuration, an edge of cutting blade 322 may be partially or fully exposed to cut items, such as sausage casings that are brought into contact with the blade 322. When mounted, the cutting assembly 300 may face the front portion 102 of the base member 200.

Various means for configuring and operating the knife assembly 100 are described below.

In the various exemplary embodiments, the base member 200 may be configured to attach the knife assembly 100 to a support structure, such as a planar working surface. The base member 200 may provide a substantially stable mounting base for the cutting assembly 300 to be mounted therein. The base member 200 may be of any size or shape suitable for this purpose. For example, in the exemplary embodiment illustrated in FIGS. 1A and 1B, the base member 200 generally has a parallelepiped shape.

The base member 200 may have a front surface 202, a back surface 206, a top surface 204, two side surfaces 208, and a bottom surface 210. In the various exemplary embodiments, the base member 200 may further have a structure-mounting portion 220, and a cutting-assembly mounting portion 250. The structure-mounting portion 220 may be configured generally to mount the knife assembly 100 to a support structure, such as a table or other work surface. The structure-mounting portion 220 can be adapted to secure to the support surface using one or more of various suitable means, including mechanical, adhesive, magnetic, or other suitable means of attachment.

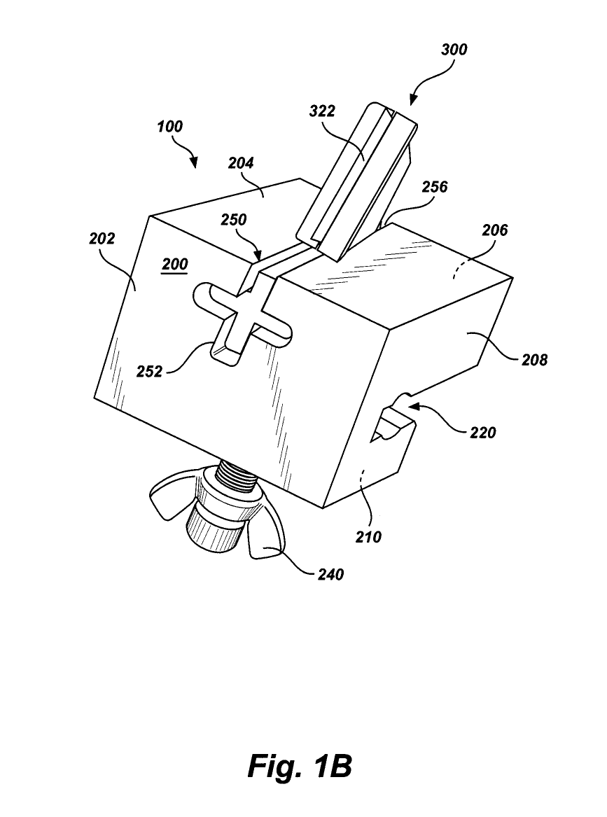

Referring to the exemplary embodiments in FIG. 2, the structure-mounting portion 220 of the base member 200 may have an opening 222 adapted to receive a support structure. In the exemplary embodiment, the opening 222 may extend from the back surface 206 of the base member 200, through to the central portion of the base member 200. The opening 222 may generally be described as a horizontal slot that, in one exemplary embodiment extends from side surface 208 to opposite side surface 208 and terminates in two open ends. Further, the opening 222 may generally be defined by an upper surface 224, a lower surface 226, and a front (end) surface 228. The opening 222 may generally have a size and shape suitable for receiving the respective support surface. For example, opening 222 may be configured to receive a generally planar surface, such as the edge of a table, by providing a generally planar upper and lower surface 224, 226. In one exemplary embodiment, the opening 222 may extend along the entire width of the base member 200 such as to receive a surface that is wider than the base member 200. In some embodiments, the opening 222 may be adapted to receive a corner of a surface. However, it is appreciated that the base member 200 may have an opening 222 and components thereof that are adapted to receive other various support surfaces.

In various embodiments, the upper surface 224 or the lower surface 226 or both may have one or more surface features that assist in the receiving, positioning, or securing of the base member 200 to the mounting surface. For example, in various embodiments, the upper surface 224 or the lower surface 226 or both may have at least one concave portion 230 that curves away from the mounting surface. The curved portion 230 may be have a continuous curved surface, or have a combination of surfaces that, in aggregate, form a generally curved surface. The curved portion may extend horizontally along the entire length of the opening 222. The curved portion 230 may assist in mounting of the base 200 by reducing the friction between a support structure, and the upper or lower surfaces 224, 226 in the curved portion 230, or by increasing the mounting force in the non-curved portions of upper or lower surfaces 224, 226. In various exemplary embodiments, the upper or lower surfaces 224, 226, may have gripping surface features on a portion of the surfaces 224, 226, which improve the gripping ability of the base member 200.

Still referring to the exemplary embodiments illustrated in FIG. 2, the structure-mounting portion 220 of the base member 200 may further comprise a fastener 240 for securing the base member 200 to a support structure. In exemplary embodiments, the fastener 240 may be a threaded bolt 242, which may be adapted to screw through the base member 200 and into or against the support structure. For example, in the embodiment illustrated in FIG. 2, the base member 200 may have a hole 244 that extends between the lower surface 226 of the surface mounting portion 220 and the bottom 210 of base member 200. The hole 244 may be adapted to receive a threaded screw, such as bolt 242. The hole 244 may be threaded to correspond to the threads of the bolt 242, or may be unthreaded. In use, when a supporting surface is inserted into opening 222, the bolt 242 can be screwed through the hole 244, so that it bears on one surface of the supporting surface, forcing the support surface upward toward the upper surface 224 of the opening.

In other exemplary embodiments, the fastener 240 may include the bolt 242, which extends through the hole 244 in the lower surface 226, and further into a hole (not illustrated) in the upper surface 224 of the surface-mounting portion. In use, the bolt 242 may be screwed into the base member 200, so as to bring the upper surface 224 and lower surface 226 toward each other, thereby constricting the opening 222. In one embodiment, there may be more than one bolt 242, one of which secures from the top and the other from the bottom. In another embodiment, there may be only one bolt 242 that secures from the top. When a support surface is inserted into the opening 222, the upper and lower surfaces 224, 226, may compress the support surface, fastening the base member 200 to the surface. The fastener 240 may include one or more additional features to assist in tightening and/or securing the fastener, such as a finger screw or wingnut.

It will be appreciated that the structure-mounting portion 220 of the base member 200 may be configured to secure to a support structure in a number of alternative ways. For example, the structure-mounting portion 220 may be adapted to snap on to a surface, adhesively secure to a surface, magnetically secure to a surface, and so on.

Referring back to FIGS. 1A and 1B, the base member 200 may include a cutting assembly mounting portion 250 adapted to receive or couple with the cutting assembly 300. In various embodiments, the cutting assembly 300 may be unitary with the base member 200, so that the cutting assembly 300 and base member 200 may be joined at cutting assembly mounting portion 250. In various embodiments, cutting assembly 300 may be a separate part that may be removable from base 200. For example, in various embodiments, it may be advantageous to provide a separately removable and replaceable cutting assembly 300, so that when the cutting blade 322 becomes ineffective, the cutting assembly 300 may be replaced without replacing the entire knife assembly 100. In the various embodiments, the cutting assembly mounting portion 250 has features, described in more detail below, that are suitable for receiving and securing the cutting assembly 300.

In various embodiments, the base member 200 and its components may generally be made of plastic material, e.g. polyethylene or polypropylene. In various exemplary embodiments, the base member 200 and its components may generally be made from extruded and machined plastic. For example, a suitable extrusion process allows the unfinished parts to be made relatively economically and efficiently. Moreover, a suitable extrusion process enables the production of the base member 200 having critical surfaces and details that can be finished or machined to required tolerances. In other exemplary embodiments, some or all of the base member 200 and its components may be made from other suitable materials, such as stainless steel. These and other variations will be understood in view of the present disclosure. It will also be understood that the base member 200 shown in the embodiments is not limited to any particular size or shape. Further variations of the features described herein may be made by those of ordinary skill in the art.

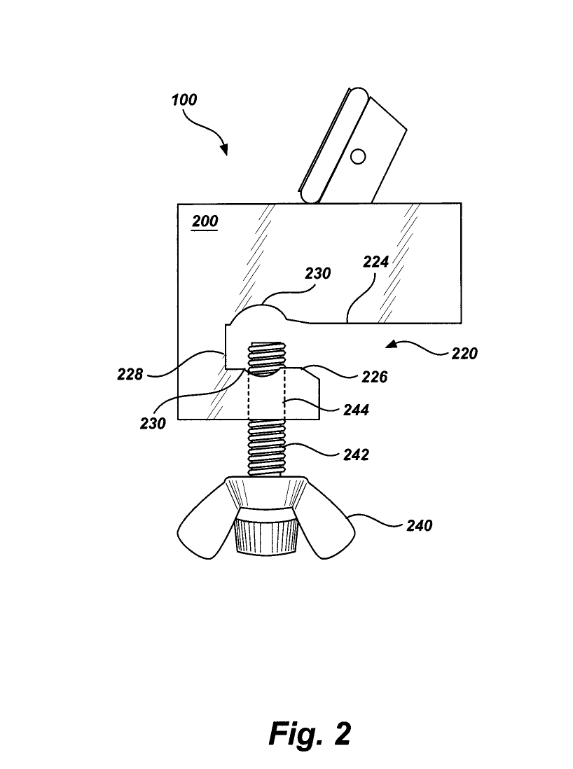

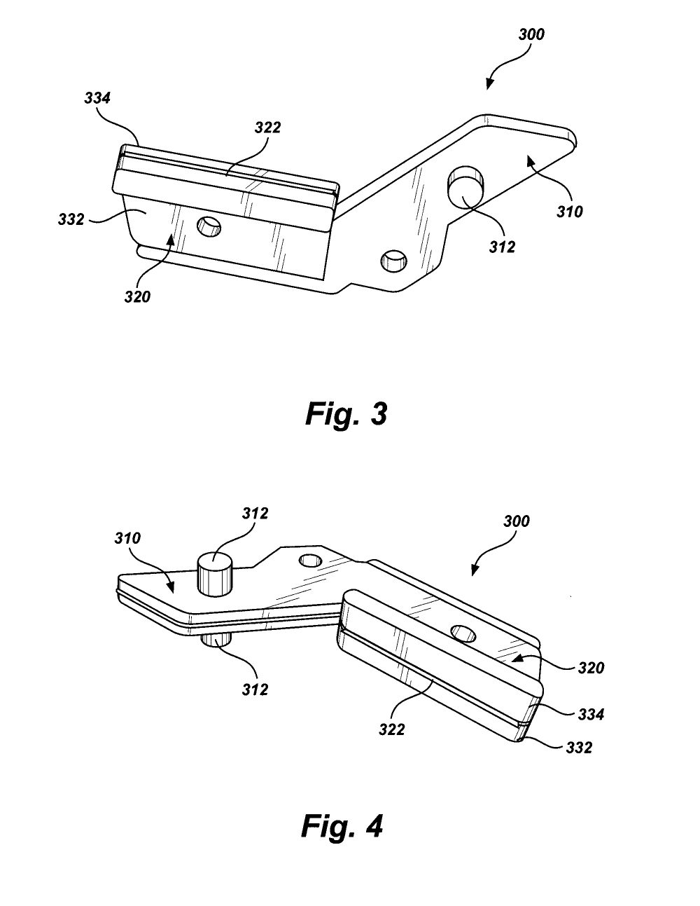

As illustrated in FIGS. 3 and 4, in exemplary embodiments, cutting assembly 300 may generally have a mounting arm 310, such as for mounting the cutting assembly 300 to base member 200, and a cutting blade portion 320. The mounting arm 310 and the cutting blade portion 320 may be unitary with respect to each other, or may be separate parts that are coupled with each other. As illustrated in FIGS. 3 and 4, mounting arm 310 may extend from one side of the cutting blade portion 320. In various embodiments, the mounting arm 310 and cutting blade portion 320 may be joined at any suitable angle that positions the cutting blade 322 in a desired position relative to a support structure, and the product to be cut, when the cutting assembly 300 is mounted on base member 200.

In various embodiments, the cutting blade portion 320 is adapted to rigidly hold a cutting blade 322. In exemplary embodiments, cutting blade 322 may be a relatively flat blade. In exemplary embodiments, the cutting blade portion 320 may comprise a first half 332, and a second half 334 that cooperate to hold the blade 322 therebetween. For example, the blade 322 may be inserted between the first and second half 332, 334. In various exemplary embodiments, the first and second half 332, 334 are removable so that the cutting blade 322 may be inserted, removed, or replaced.

In exemplary embodiments, when the blade 322 is assembled in the cutting blade portion 320, an edge of the cutting blade 322 may be exposed, as best illustrated in FIGS. 3 and 4. In exemplary embodiments, an edge of the cutting blade 322 may extend by about 1 millimeter to about 2 millimeters from the cutting blade portion 320. In exemplary embodiments, the cutting blade 322 extends only so far as necessary to cut the surface of the work product, but not so far as to pose a serious risk of injury to a user of the knife assembly 100. For example, when the cutting blade 322 extends only a few millimeters, it may only cause a superficial cut to a user's hand. It will be appreciated that, when designing the cutting assembly 300, there may be a trade-off between the cutting efficiency and the safety risk.

In various embodiments, the cutting assembly 300 and its components may generally be made of any material suitable for supporting and holding a blade. In exemplary embodiments, the components may be made of a plastic material, e.g. polyethylene or polypropylene. In various exemplary embodiments, the components may generally be made from extruded and machined plastic. In other exemplary embodiments, the components may be made from other suitable materials, such as stainless steel. These and other variations will be understood in view of the present disclosure.

In various embodiments, the cutting blade 322 may generally be made of any materials suitable for providing a sharp cutting edge. In exemplary embodiments, the cutting blade 322 is made of a durable material that holds its edge for a substantial period of time without sharpening. In various embodiments, the cutting blade 322 is made of a material that is relatively inexpensive, so that it may be disposable. It will be understood that further variations of the features described herein may be made by those of ordinary skill in the art.

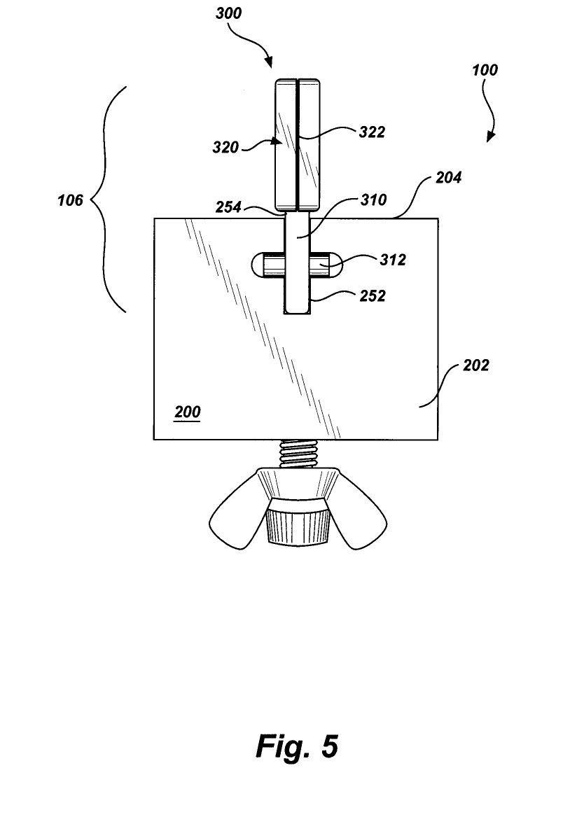

In exemplary embodiments, the mounting portion 310 is adapted to be joined with or coupled with the cutting-assembly mounting portion 250 of the base member 200. Referring FIGS. 4 and 5, in various exemplary embodiments, the cutting-assembly mounting portion 250 of the base member 200 is adapted to be joined with or coupled with the mounting arm 310 of the cutting assembly 300. For example, in various exemplary embodiments, the mounting arm 310 may have a substantially planar structure projecting from the cutting blade portion 320, and the cutting-assembly mounting portion 250 of the base member 200 may have a corresponding first opening 252 and a slot 254, both having a size and shape adapted to receive the mounting portion 310. It will be appreciated that mounting features of the base member 200 and cutting assembly 300 could be reversed, so that the cutting-assembly mounting portion 250 may instead have a projection adapted to be received by a corresponding opening in the mounting arm 310.

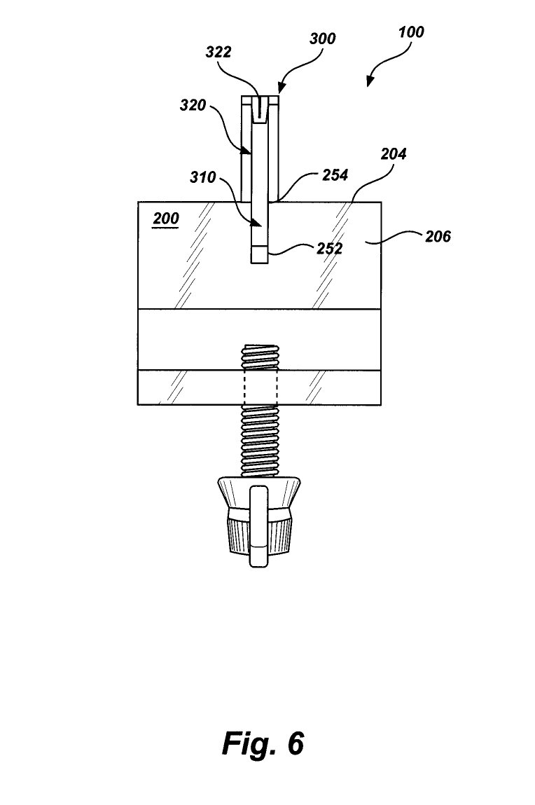

In various embodiments, the mounting arm 310 of the cutting assembly 300 may have one or more features that are adapted to couple or engage with corresponding parts of the cutting-assembly mounting portion 250 of the base member 200. For example, as illustrated in FIGS. 3 and 4, in various embodiments the mounting arm 310 may have at least one boss 312 projecting therefrom. Likewise, the first opening 252 and the slot 254 of the cutting-assembly mounting portion 250 may be adapted such that they may receive the at least one boss 312, when the cutting assembly 300 is coupled with the base member 200, as best shown in FIG. 5. In an exemplary embodiment, the one or more bosses 312 may project orthogonally from the mounting arm 310, and may have any size or shape suitable for engaging with the cutting-assembly mounting portion 250 of the base member 200. As illustrated in FIGS. 5 and 6, in an exemplary embodiment, the mounting arm 310 of the cutting assembly has two bosses 312 extending from opposite sides of the mounting arm 310.

It will be appreciated that, while the mounting features are described above in reference to bosses and slots, other suitable mounting features may be provided to one or more of the parts, to mechanically, adhesively, or otherwise join or couple the cutting assembly 300 with the base member 200. When the base member 200 and cutting assembly 300 are joined or coupled together, they provide a stable knife assembly.

In various embodiments, the mounting arm 310 of cutting assembly 300 and its components may generally be made of any suitable material. In exemplary embodiments, the mounting arm 310 may be made of a plastic material, e.g. polyethylene or polypropylene. In various exemplary embodiments, the mounting arm 310 and its components may generally be made from extruded and machined plastic. In other exemplary embodiments, some or all of the mounting arm 310 and its components may be made from other suitable materials, such as stainless steel. These and other variations will be understood in view of the present disclosure.

Again referring to FIGS. 5 and 6, in exemplary embodiments, the cutting assembly 300 may be coupled with base member 200 in such a way that the cutting assembly 300 may be rigidly and securely held in place. To do so, the mounting arm 310 of the cutting assembly 310 may fit securely and rigidly into the slot 254, which in whole or part extends through the base member 200. In various embodiments, the slot 254 may extend from the first opening 252 through all or a portion of the base member 200. In an exemplary embodiment, the slot 254 may extend through the upper portion 106 of the knife assembly 100, such that it is in communication with the front 202 and back 206 of the base member 200. That is, the slot 254 may extend from the first opening 252, through the upper portion 106 of the base member 200, to the second opening 256. The slot 254 may be have a travel stop, such that the cutting assembly 300 is securely held in the base member 200 at a predetermined distance when the one or more bosses 312 abut against the travel stop. In other words, a portion of the slot 254 that aligns with and receives the one or more bosses 312 may terminate at some point inside the base member 250, creating a travel stop, which serves as an abutment for the one or more bosses 312, thereby allowing the cutting assembly 300 to be securely and rigidly mounted into the base member 200.

In various embodiments, the slot 254 may be open at the top 204 of the base member 200. Thus, when the cutting assembly 300 is inserted into the slot 254 until the one or more bosses 312 abut against a terminating end of the slot 254, the cutting blade portion 320 may be exposed above the base member 200 with the cutting blade 322 facing the front 202 of the base member 200.

In various embodiments, to use the knife assembly 100, the cutting assembly 300 may be mounted to the base member 200, as described above. The base member 200 may then be mounted to a support structure, such as a planar surface. With the cutting blade 322 facing outward, a user may run a sausage across an exposed edge of the cutting blade 322, thereby removing its casing.

In the preceding specification, various preferred exemplary embodiments have been described with reference to the accompanying drawings. It will, however, be evident that various modifications and changes may be made thereto, and additional exemplary embodiments may be implemented, without departing from the broader scope of the embodiments as set forth in the claims that follow. The specification and drawings are accordingly to be regarded in an illustrative rather than restrictive sense.

1. A knife assembly for removing a meat casing, the assembly comprising:
a base member adapted to be mounted to a support structure, the base member comprising:
a cutting assembly mounting portion having a first opening located on a surface of the base member and a slot, the slot extending from the first opening through the base member to a second opening on another surface of the base member;
a cutting assembly comprising:
a mounting arm configured to engage the slot to couple the cutting assembly to the base member;
a cutting blade portion adapted to hold a blade, wherein at least a portion of a sharp edge of the blade is exposed.

2. The assembly of claim 1, wherein the base member further comprises a mounting space adapted to receive a portion of the support structure therein.

3. The assembly of claim 1, wherein the base member further comprises a fastener for securing the base member to the support structure.

4. The assembly of claim 3, wherein the mounting space forms a horizontal slot adapted to receive a planar projection, wherein a bolt tightens the mounting space against the planar projection to hold the base member in place.

5. The assembly of claim 1, wherein the mounting arm of the cutting assembly comprises one or more bosses.

6. The assembly of claim 1, wherein one or more portions of the slot extend from the first opening through the base member to the second opening in the back surface of the base member.

7. The assembly of claim 5, wherein one or more portions of the slot extend from the first opening through only portion of the base member and are adapted to receive and engage the one or more bosses, thereby securely holding the cutting assembly at a predetermined distance in the base member.

8. The assembly of claim 1, wherein the sharp edge of the blade is exposed by 2 millimeters or less.

9. A knife assembly for removing a meat casing, the assembly comprising:
a base member comprising a mounting portion adapted to mount to a support structure, wherein the mounting portion comprises a mounting opening extending from two opposite side surfaces of the base member and further defined by a front surface, and a cutting assembly mounting portion; and
a cutting assembly adapted to mount to the cutting assembly mounting portion, the cutting assembly comprising a blade, wherein at least a portion of a sharp edge of the blade is exposed.

10. The assembly of claim 9, wherein the base member further comprises a first opening and a second opening, wherein the first and second opening are in communication via a slot.

11. The assembly of claim 10, wherein the slot comprises one or more portions.

12. The assembly of claim 9, wherein the cutting assembly comprises a mounting arm configured to engage a slot in the base member so as to couple the cutting assembly to the base member.

13. The assembly of claim 12, wherein the mounting arm, when engaged with the slot, positions the sharp edge of the blade such that it faces away from the support structure.

14. A knife assembly for removing a meat casing, the assembly comprising:
a base member adapted to be mounted to a support structure, the base member comprising a cutting assembly mounting portion;
a cutting assembly comprising:
a mounting arm configured to engage the cutting assembly mounting portion;
a cutting blade portion adapted to hold a blade; and
wherein the mounting arm and cutting blade portion are joined at an angle to allow the cutting blade portion to reside atop the base member when the cutting assembly is coupled to the base member.

15. The assembly of claim 14, wherein the cutting assembly mounting portion comprises a first opening located on a front surface of the base member, the first opening being in communication with a second opening, which is located on a back surface of the base member.

16. The assembly of claim 14, wherein the base member further comprises a mounting space adapted to receive a portion of the support structure therein.

17. The assembly of claim 16, wherein the base member further comprises a fastener for securing a planar support structure inside of the mounting space.

18. The assembly of claim 14, wherein the mounting arm of the cutting assembly comprises one or more bosses configured to engage a slot in the base member so as to rigidly secure the cutting assembly to the base member.

19. The assembly of claim 14, wherein the mounting arm and cutting blade portion are unitary.

20. The assembly of claim 14, wherein the mounting arm and cutting blade portion are removably and pivotally joined.
